(19) United States
(12) Patent Application Publication
(10) Pub. No.: US 2022/0020299 A1
(43) Pub. Date: Jan. 20, 2022

(54) SIGN FOR ON-BOARD USE IN RIDE SHARING VEHICLES

(71) Applicant: Edward MAURO, Oldsmar, FL (US)

(72) Inventor: Edward MAURO, Oldsmar, FL (US)

(21) Appl. No.: 17/377,602

(22) Filed: Jul. 16, 2021

Related U.S. Application Data
(60) Provisional application No. 63/052,698, filed on Jul. 16, 2020.

(51) Int. Cl. G09F 9/33; G06F 3/14; H04M 1/724; G09F 21/04; B60Q 1/26

(52) U.S. Cl. CPC G09F 9/33; G06F 3/1423; B60Q 1/26; G09F 21/0485; H04M 1/724

(57) ABSTRACT

A sign for on-board use in ride sharing vehicles comprising a case having front and rear portions and the case is configured to be removably coupled to an inside of a windshield. The sign also includes at least one visual display carried by the front portion of the case, and a power supply coupled to the at least one visual display. In addition, the sign includes a plurality of electronic components coupled to a remote application, the power supply, and the at least one visual display. The electronic components are configured to receive a name of a rider from the remote application and to display the name on the at least one visual display.

### RELATED APPLICATIONS

This application claims priority to Provisional Application Ser. No. 63/052,698 filed Jul. 16, 2020, the contents of which are hereby incorporated by reference in their entirety.

### TECHNICAL FIELD

The present invention relates to the field of ride sharing, and, more particularly, to a sign for on-board use in ride sharing vehicles.

### BACKGROUND

A ride sharing driver is typically screened by a ride sharing company such as Uber or Lyft. Once the driver has passed the initial screening and is authorized to provide transportation, the driver can log into an application using a smartphone that determines the current location of the driver and vehicle. Accordingly, when a rider logs into the application and requests transportation, the application determines which ride sharing vehicles are nearest the location and available to provide the requested transportation to the rider. The rider (or the application) selects one of the available vehicles to provide the transportation. The application displays the type of vehicle and name of the driver to the rider. Thus, the rider can be on the lookout for a particular vehicle that will be providing the transportation.

However, recently riders have been getting into the wrong vehicle and nefarious characters have taken advantage of the rider due to the confusion and can be difficult at night or in crowded airports or city streets to locate the specific type of car picking you up. Accordingly, there is a need in the art to increase safety to riders using ride sharing services.

### SUMMARY

A sign for on-board use in ride sharing vehicles is disclosed. The sign includes a case having front and rear portions and the case is configured to be removably coupled to an inside of a windshield. The sign also includes at least one visual display carried by the front portion of the case, and a power supply coupled to the at least one visual display. In addition, the sign includes an electronic component coupled to a remote application, the power supply, and the at least one visual display. The electronic component is configured to receive a name of a rider and/or the driver name from the remote application and to display the name(s) on the at least one visual display.

### BRIEF DESCRIPTION OF THE DRAWINGS

FIG. 1 is a right side perspective view of a sign for on-board use in ride sharing vehicles;

FIG. 2 is a left side perspective view of the sign for on-board use in ride sharing vehicles of FIG. 1;

FIG. 3 is a rear perspective view of the sign for on-board use in ride sharing vehicles of FIGS. 1 and 2; and

FIG. 4 is a block diagram of the sign of FIGS. 1 and 2.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

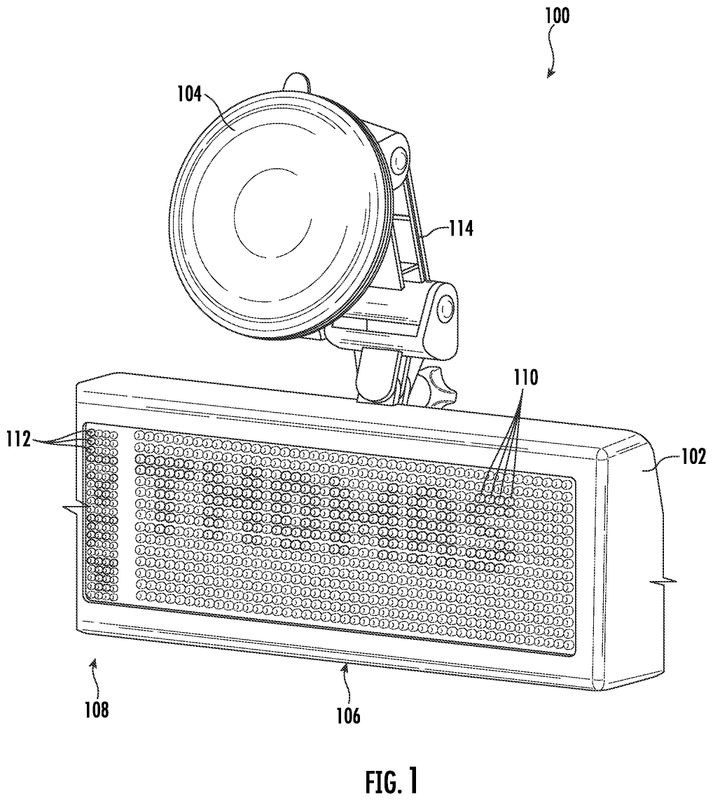

Referring now to FIGS. 1-3, a sign for on-board use in ride sharing vehicles is shown and generally designated 100. The sign 100 includes a case 102 for housing electronics for first and second visual displays 106, 108. In particular, the first visual display 106 includes an array of LEDs 110 that is configured to light up to display a name of the rider and/or driver.

For example, as shown in FIG. 1 the name “THOMAS” is displayed on the first visual display 106. The second visual display 108 also includes an array of LEDs 112 and is configured to display the name of the ride sharing company such as “LYFT”, for example, as shown in FIG. 1. As those of ordinary skill in the art can appreciate, the first and second visual displays 106, 108 may comprise any suitable type of display screen and is not limited to an array of LEDs as described herein. The LEDs can be multiple colors, brightness can be adjusted, LEDs can flash alternately “LYFT” or “USER” then “RIDERS” name or one or both.

The case 102 is removably secured to the inside of a windshield using a suction cup 104, adhesive, magnets, or other suitable fasteners. The case 102 is suspended from the suction cup 104 by an adjustable arm 114. The arm 114 is configured to adjust an angle of the case 102 so that the first and second visual displays were easy to read from outside the vehicle.

A power switch 120 is positioned on a side of the case 102 in order to power on electronic components 125 and turn on the first and second visual displays 106, 108. The power source 121 may be an independent power source such as a battery, for example, housed within the case 102 and coupled to the visual displays 106, 108 and the electronic components 125. As those of ordinary skill in the art can appreciate, the sign 100 may also be powered by a power source of the vehicle.

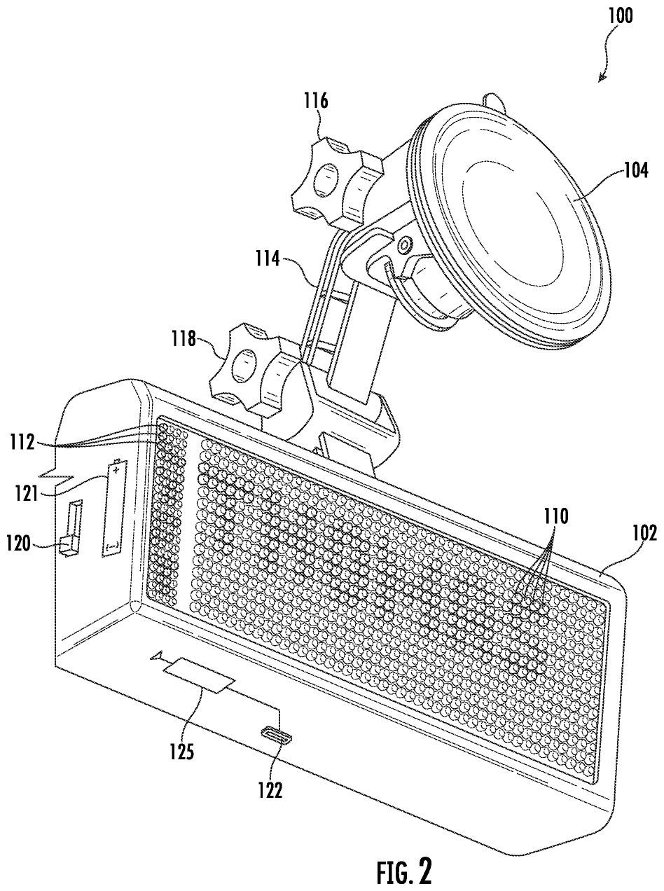

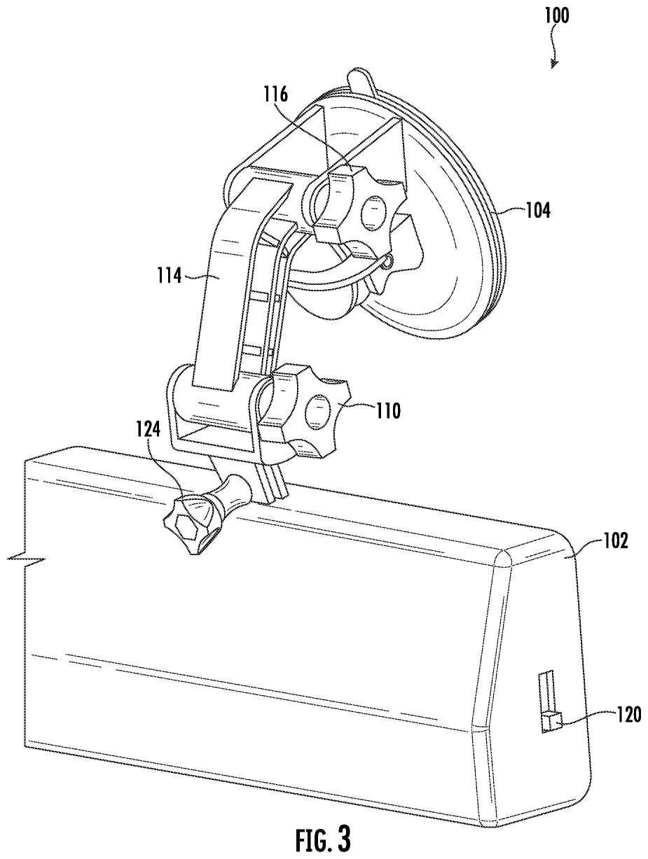

Referring now to FIGS. 2 and 3, a USB port 122 may be located on the bottom of the case 102 and may be used to power the sign 100 and/or to program the electronic components (e.g., memory, processor). As explained above, the electronic components 125 are coupled to the first and second visual displays 106, 108 and can be programmed to display a desired name, for example, on the first visual display 108.

The arm 114 may adjusted using a top adjustment wheel 116 to adjust an angle of the suction cup 104 to the inside of the windshield. A bottom adjustment wheel 118 may similarly be used to adjust the angle of the visual displays 106, 108 to the rider standing outside the vehicle. A bolt 124 may be used to secure the case 102 to the arm 114.

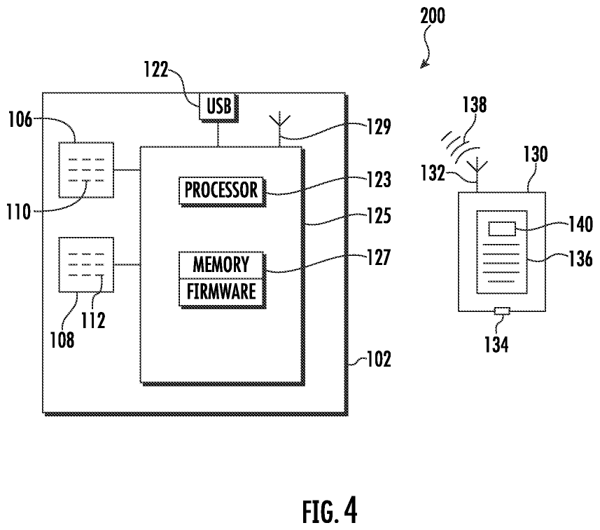

Referring now to FIG. 4, a block diagram of a system 200 of the sign 100 is depicted. The case 102 houses the electronic components 125 that may include a processor 123 and a memory 127 that stores data to display and firmware to operate the first visual display 106 and the second visual display 108. The sign 102 may include an antennae 129 for receiving wireless signals 138 transmitted using an antenna 132 from a computing device 130 such as a smartphone.

The computing device 130 may have an application 140 stored thereon or that is otherwise accessible using a user interface 136 of the computing device 130. The computing device 130 may have a port 134 that provides a wired connection to the port 122 of the sign 102.

In operation, the application 140 stored on the computing device (e.g. smartphone) 130 of the driver connects via Bluetooth (or USB port, for example) to the sign 100. The driver can manually type the name of the rider to display on the first visual display 106, or the application can transmit directly to sign 100 (via Bluetooth or USB port, for example) and automatically display the name of the rider. The name of the driver can also be displayed on the first visual display 106 (or second visual display 108). Accordingly, the rider can visually determine which vehicle is the correct vehicle by reading the visual display 106. The name of the company (and/or driver) may also displayed on the second visual display 108 to further confirm to the rider that she is getting into the correct vehicle.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A sign for on-board use in ride sharing vehicles, the sign comprising:
a case having front and rear portions and the case configured to be removably coupled to an inside of a windshield;
a first visual display carried by the front portion of the case;
a power supply coupled to the at least one visual display; and
a plurality of electronic components within the case and configured to be coupled to a remote application, the power supply, and the first visual display, wherein the plurality of electronic components is configured to receive a name of a rider from the remote application and to display the name on the first visual display.

2. The sign of claim 1, wherein the first visual display comprises a first array of light emitting diodes (LEDs) configured to display the name of the rider that requested a ride from a ride sharing company.

3. The sign of claim 2, further comprising a second visual display having a second array of LEDs and configured to display a name of the ride sharing company correlated to the name of the rider who requested the ride.

4. The sign of claim 3, wherein the LEDs of the first and second visual displays comprise multiple colors and are configured to adjust a brightness and to flash intermittently.

5. The sign of claim 4, further comprising an arm having a first end coupled to the case and a second end having a suction cup configured to be removably secured to the inside of the windshield so that the case is suspended from the suction cup by the adjustable arm.

6. The sign of claim 5, further comprising a power switch positioned on a side of the case in order to power on the plurality of electronic components and turn on the first and second visual displays.

7. The sign of claim 6, wherein the power source comprises a battery housed within the case and coupled to the first and second visual displays.

8. The sign of claim 7, further comprising a universal serial bus (USB) port located on a bottom of the case, wherein the USB port is configured to be coupled to an electronic device to program the electronic components.

9. The sign of claim 8, wherein the plurality of electronic components comprise a memory and a processor, and are configured to be programmed to display the name of the rider on the first visual display.

10. The sign of claim 5, wherein the arm comprises a top adjustment wheel configured to adjust an angle of the suction cup to the inside of the windshield.

11. The sign of claim 10, wherein the arm comprises a bottom adjustment wheel configured to adjust the angle of the first and second visual displays.

12. The sign of claim 1, wherein the remote application is configured to be stored on a smartphone and configured to connect via wireless signals or the USB port to the electronic components.

13. The sign of claim 12, wherein the remote application is configured to receive the name of the rider to display on the first visual display using a user interface of the smartphone.

14. A sign for on-board use in ride sharing vehicles, the sign comprising:
a case having front and rear portions and the case configured to be removably coupled to an inside of a windshield;
a first visual display carried by the front portion of the case;
a power supply coupled to the at least one visual display;
a remote application configured to be stored on a smartphone; and
a plurality of electronic components within the case and configured to be coupled to the remote application, the power supply, and the first visual display, wherein the plurality of electronic components is configured to receive a name of a rider from the remote application and to display the name on the first visual display.

15. The sign of claim 14, wherein the remote application is configured to connect via wireless signals or the USB port to the electronic components.

16. The sign of claim 15, wherein the first visual display comprises a first array of light emitting diodes (LEDs) configured to display the name of the rider that requested a ride from a ride sharing company.

17. The sign of claim 16, further comprising a second visual display having a second array of LEDs and configured to display a name of the ride sharing company correlated to the name of the rider who requested the ride.

18. The sign of claim 17, wherein the LEDs of the first and second visual displays comprise multiple colors and are configured to adjust a brightness and to flash intermittently.

19. A sign for on-board use in ride sharing vehicles, the sign comprising:
a case having front and rear portions and the case configured to be removably coupled to an inside of a windshield;
a first visual display carried by the front portion of the case;
a remote application configured to be stored on a smartphone;
a plurality of electronic components within the case and configured to be coupled to the remote application, wherein the plurality of electronic components is configured to receive a name of a rider from the remote application and to display the name on the first visual display.

20. The sign of claim 19, further comprising a universal serial bus (USB) port located on a bottom of the case, wherein the USB port is configured to be coupled to the smartphone to program the electronic components.
